(19) United States
(12) Patent Application Publication
(10) Pub. No.: US 2024/0353365 A1
(43) Pub. Date: Oct. 24, 2024

(54) COMPOSITION AND PROCESS OF MANUFACTURING AN ELECTRODE, ELECTRODE AND ELECTROCHEMICAL GAS SENSOR

(71) Applicant: Dräger Safety AG & Co. KGaA, Lübeck (DE)

(72) Inventors: Michael SICK, Lübeck (DE); Marie-Isabell MATTERN-FRÜHWALD, Lübeck (DE); Susanne SCHENK, Lübeck (DE)

(21) Appl. No.: 18/637,586

(22) Filed: Apr. 17, 2024

(30) Foreign Application Priority Data
Apr. 19, 2023 (DE) 10 2023 109 869.1

(51) Int. Cl. G01N 27/30

(52) U.S. Cl. CPC G01N 27/308

(57) ABSTRACT

An electrode for use in an electrochemical gas sensor for measuring alcohol, a composition for making such an electrode, a process for making an electrode, and an electrochemical gas sensor including such an electrode are provided. The electrode includes a metal adapted and configured to react alcohol and a non-metallic material. The non-metallic material comprises glass, in particular silicon dioxide, silicate, polypropylene and/or polyethylene.

### CROSS REFERENCE TO RELATED APPLICATIONS

This application claims the benefit of priority under 35 U.S.C. § 119 of German Application 10 2023 109 869.1, filed Apr. 19, 2023, the entire contents of which are incorporated herein by reference.

### TECHNICAL FIELD

The present invention relates to a composition for making an electrode for use in an electrochemical gas sensor for measuring alcohol, a process for making the electrode, the electrode and an electrochemical gas sensor comprising such an electrode.

### BACKGROUND

Electrodes for electrochemical gas sensors and electrochemical gas sensors are known.

Electrochemical gas sensors have at least one measuring electrode at which a conversion (reaction)—in particular an oxidation—of an analyte (i.e. a gas or vapor to be measured) as a potential component of a sample gas takes place during operation. This conversion leads to a measurable electrical quantity from which a statement can be made about the concentration of the analyte in the sample gas. In this way, the analyte, e.g. alcohol, can be measured quantitatively or qualitatively.

Electrochemical gas sensors also have at least one counter-electrode at which a counter-reaction occurs. For example, the counter-reaction can be a reduction of oxygen.

Optionally, an electrochemical gas sensor can also have a reference electrode that provides an electrical reference potential. A suitable device such as a potentiostat can be used to determine the respective working potentials of the measuring electrode and counter electrode relative to the reference potential of the reference electrode.

Depending on the analyte to be converted (reacted), the electrochemical gas sensor must be configured accordingly. The choice of a suitable electrode is crucial for this.

U.S. Pat. No. 2,019,246 958 A1 discloses an electrode for an electrochemical gas sensor for measuring alcohol, which consists of platinum.

U.S. Pat. No. 9,816,959 B discloses an electrode for an electrochemical gas sensor for measuring alcohol, which comprises a material selected from iron, gold, nickel, platinum, carbon or a combination thereof.

EP 1 326 075 A1 discloses an electrode for an electrochemical gas sensor for measuring alcohol, which consists of a mixture of sintered platinum black and PTFE.

When measuring alcohol as an analyte, electrochemical gas sensors generally have the problem that not only the analyte is converted at the electrode, but also other gases or vapors contained in the sample gas can be converted. The sample gas often contains CO (also known as carbon monoxide or carbon monoxide), especially when measuring in an industrial environment. The simultaneous conversion of CO and alcohol at the measuring electrode generates a larger measurable electrical quantity, which leads to a falsified measurement of the alcohol or leads to a misinterpretation of the measurement result.

### SUMMARY

It is therefore an object of the present invention to provide a composition for producing an electrode for use in an electrochemical gas sensor for measuring alcohol, the measurement behavior of which is improved with respect to alcohol, in particular in the presence of CO.

These and other objects are attained by a composition, process, electrode and electrochemical gas sensor according to the invention.

This disclosure including the description, drawings and claims provide advantageous embodiments of the invention.

According to the invention, there is disclosed in this respect a composition for producing an electrode for use in an electrochemical gas sensor for measuring alcohol. The composition and the electrode obtainable therewith comprise a metal adapted (configured) to react alcohol and a non-metallic material. The non-metallic material comprises glass (in particular silicon dioxide). The composition further comprises a dispersant.

In the context of the invention, it was surprisingly found that the composition according to the invention and the electrode obtainable therefrom have an improved selectivity and sensitivity for the conversion of alcohol than known electrodes, in particular than known electrodes based on platinum or a platinum/PTFE composite.

The electrode according to the invention causes a change in the electrochemical behavior of the three-phase boundary that forms during operation, so that the analyte, i.e. alcohol, is better converted at the electrode than with known electrodes. In particular, alcohol can be converted more strongly than CO in this way, so that the electrode according to the invention advantageously has an overall improved selectivity and sensitivity to alcohol and an advantageously reduced cross-sensitivity to CO.

In the context of the invention, an alcohol is understood in the most general case to be an organic chemical compound which has one or more hydroxyl groups (—O—H) bonded to aliphatic carbon atoms. Preferably, an alcohol is specifically understood to mean ethanol (C2H6O) and/or methanol (CH3OH).

According to the invention, the electrode is particularly preferably configured as a composite material consisting of at least two base materials, with the metal forming a first base material and the non-metallic material forming a second base material. In this case, the metal and the non-metallic material are present in the electrode in a (preferably unevenly) locally distributed manner.

Preferably, the electrode has a metal that is adapted (configured) to catalytically react (convert) the analyte, i.e. alcohol. In this way, oxidation of the analyte at the electrode and thus the conversion of the analyte can be promoted. However, electrode designs are also possible in which no catalytic conversion of the analyte takes place.

A glass is understood to be a material comprising or consisting of silicon dioxide (SiO2), i.e. an inorganic, non-metallic glass.

In a variant of the invention, the glass can consist of silicon dioxide and is in this case also referred to as quartz glass.

In a further variant of the invention, the glass may comprise other components in addition to silicon dioxide, in particular oxides such as aluminum oxide, alkali oxide, phosphorus pentoxide and/or boron trioxide. The glass may further additionally or alternatively comprise halide ions.

A silicate is understood to be a salt and/or an ester of an ortho-silicic acid (Si(OH)4) and its condensates. The silicate can be present in crystalline or amorphous structure or comprise a mixture of silicates in crystalline structure and silicates in amorphous structure.

Furthermore, the electrode is particularly preferably adapted (configured) to be in contact with an acidic electrolyte, as this combination of features allows hydrophilic, protic analytes such as alcohol to be specifically converted, while the conversion of undesirable aprotic compounds such as CO can be largely prevented.

The acid electrolyte in operation is particularly preferably a liquid electrolyte. For example, the electrolyte may comprise sulphuric acid, phosphoric acid, perchloric acid and/or trifluoromethanoic acid, for example as a component or components of an aqueous solution.

Particularly preferably, the non-metallic material comprises only glass and/or silicate. It was surprisingly found that an electrode configured in this way exhibits improved long-term stability, i.e. that the improved selectivity and sensitivity to the analyte compared to known electrodes is maintained over a particularly long period of time.

Preferably, the electrode is formed as an integral part of a layered structure, wherein the electrode is formed as a first layer of the layered structure, and wherein an inert porous carrier layer is formed as a second layer of the layered structure.

In this way, the electrode can be handled and mounted particularly easily as part of a layered structure that mechanically reinforces the electrode. In particular, this makes it possible to form the electrode as a thin layer on the carrier layer, so that the carrier layer can act as a support structure for the electrode. Furthermore, the sensitivity of the electrode to damage during assembly is reduced in this way, as the electrode is protected on at least one side by the carrier layer.

An electrode formed as an integral part of the layered structure is understood to mean that the electrode and the carrier layer are (directly or indirectly) connected in a non-detachable or conditionally detachable manner. Such a connection can be provided, for example, by joining, forming, reshaping or coating. For example, the electrode and carrier layer can be pressed together. Furthermore, for example, the electrode can be applied to the carrier layer as a fluid and the electrode can thus penetrate at least partially into the carrier layer. Application by means of fluid is possible in particular by means of a printing process such as screen printing or inkjet printing.

An inert carrier layer is understood to be a carrier layer that is inert to the electrolyte, analytes and any reaction products formed during intended operation. In other words, the carrier layer is made of a material that does not react with the aforementioned substances in the operating state of an electrochemical gas sensor.

A porous carrier layer is understood to be a carrier layer which has at least partially interconnected cavities, referred to as pores, so that the carrier layer is adapted (configured) to absorb an electrolyte.

An inert porous carrier layer is therefore understood to be a carrier layer that is both inert and porous.

Preferably, the carrier layer comprises polytetrafluoroethylene (PTFE), glass, such as borosilicate glass, or polypropylene (PP) as the material, whereby the material can be configured, for example, as a textile, such as a woven, non-woven or knitted fabric. The carrier layer can be hydrophilized to improve wetting.

Preferably, the electrode is porous.

In this way, the effective surface area available for the conversion of the analyte can be advantageously increased and its conversion at the electrode surface improved.

Preferably, the metal comprises gold, platinum, silver, iridium, ruthenium and/or rhodium.

In the context of the invention, it was found that these metals or mixtures of these metals are particularly suitable for providing the electrode according to the invention.

In addition to the elementary form of the metal, a material comprising the metal is also understood to be a chemical compound that has the metal as a component, such as a metal oxide, in particular platinum oxide or ruthenium oxide.

In the context of the invention, a particle is understood to be a physical element with a size in the nanometer range and/or micrometer range. According to the invention, the nanometer range is 0.1-999 nm, preferably 0.1-100 nm, most preferably 1-100 nm. According to the invention, the micrometer range is 1-999 μm, preferably 1-300 μm.

A particle has a structure, for example a fiber structure. A fiber structure refers to a body that is essentially elongated, i.e. a body that is larger in one dimension than in the other two dimensions. An elongated body may, for example, have an aspect ratio of 1:3 to 1:10 and preferably an essentially circular cross-section. As an alternative to the fiber structure, the particle can, for example, be configured as a spherical structure, i.e. essentially have a spherical shape.

The metal provided as particles, hereinafter also referred to as metal particles, and the non-metallic material provided as particles, hereinafter also referred to as non-metal particles, can have the same or different particle shapes.

The non-metallic particles can be configured in particular as silicate in a fiber structure and/or in a spherical structure, fumed and/or amorphous and/or crystalline silicon dioxide in a fiber structure and/or in a spherical structure, polypropylene in a fiber structure and/or in a spherical structure and/or as polyethylene in a fiber structure and/or in a spherical structure.

By providing the metal as a particle and the non-metallic material as a particle, the composition can be advantageously provided as a dispersion. Thus, the metal and the non-metallic material can be evenly distributed over the electrode, for example on the carrier layer. Furthermore, it was found in the context of the invention that the selectivity and sensitivity of the electrode to the analyte are advantageously improved by providing the metal and the non-metallic material as particles, whereby the measurement properties of the electrode can be further improved.

Preferably, the non-metallic particles are formed as glass in a fiber structure, wherein the fiber structure further preferably has a length of at least 1 μm, preferably of at least 5 μm, wherein the fiber structure further preferably has a diameter (or cross dimension/width) of at least 0.25 μm, wherein the diameter is preferably not more than 50 μm. Preferably, the fiber structure has a substantially circular cross-section.

Preferably, the fiber structure has a diameter (or cross dimension/width) of 0.65 μm and a length of 1.95 μm.

In the context of the invention, it was found that such a material has particularly good properties in terms of selectivity and sensitivity to alcohol, whereby the cross-sensitivity to CO is significantly reduced.

The glass is particularly preferably made of pure silicon dioxide.

Preferably, the dispersant is a volatile dispersant, wherein the dispersant preferably comprises: alcohol, in particular ethanol, methanol, n-propanol and/or iso-propanol, and/or water.

A volatile dispersant is preferably understood to be a dispersant whose evaporation rate is not greater than the evaporation rate of water, whereby the evaporation rate (a relative evaporation number) can be determined according to DIN 53170. For example, the evaporation rate of water determined according to DIN 53170 is 80.

The volatile dispersing agent (dispersant) is particularly preferably a highly volatile dispersing agent with an evaporation rate of less than 10 (determined according to DIN 53170).

In this way, the dispersant can be removed by evaporation.

According to the invention, there is further provided a process for producing an electrode as described above, the process comprising the steps of: providing the above described composition, applying the composition to the inert porous carrier layer, and removing the dispersant.

Application of the composition can be carried out in essentially any way. For example, a printing process such as screen printing or inkjet printing or application using doctor blades (squeegees) is suitable.

The dispersant is removed at least partially by evaporation of the dispersant.

According to the invention, an electrode obtained by the process described above is further provided.

According to the invention, an electrochemical gas sensor for measuring alcohol is also provided. The electrochemical gas sensor comprises at least one of the electrodes described above, wherein the electrode is configured as a measuring electrode, and an electrolyte which adapted (configured) to wet the electrode and the porous carrier layer, wherein all the elements mentioned can be configured as described above.

The electrochemical gas sensor can also have further components such as a number of other measuring electrodes (of the same or different configuration), one or more counter electrodes, one or more reference electrodes, one or more diffusion barriers, a housing, one or more separators, an equalizing volume for holding the electrolyte and/or contact means for making electrical contact with the electrodes.

These and other features can also be seen in the following description of the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic sectional view of an embodiment of an electrode according to the invention;

FIG. 2 is a schematic sectional view of an embodiment of a layered structure of an electrode according to the invention;

FIG. 3 is a schematic sectional view of an embodiment of an electrochemical gas sensor according to the invention;

FIG. 4 is a flow chart of an embodiment of a process according to the invention;

FIG. 5 is a first diagram with first measured values of a test with a sensor according to the invention and a known sensor; and

FIG. 6 is a second diagram with second measured values of a test with the sensor according to the invention and the known sensor.

### DESCRIPTION OF PREFERRED EMBODIMENTS

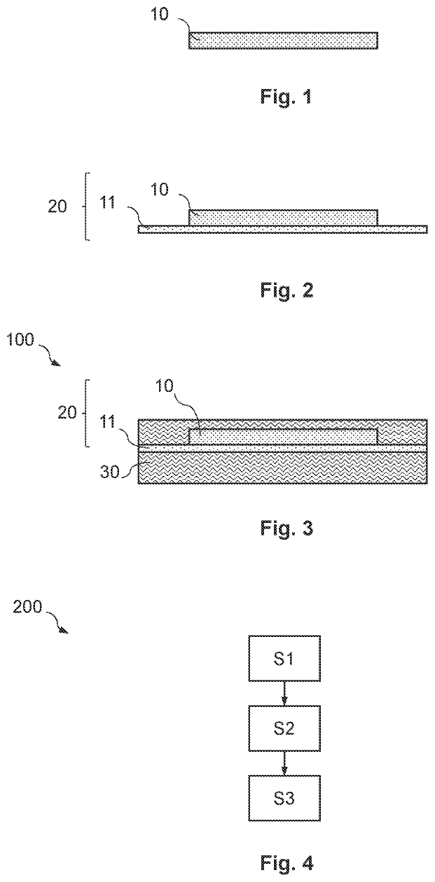

Referring to the drawings, FIG. 1 shows an embodiment example of an electrode 10 according to the invention for use in an electrochemical gas sensor 100 for measuring alcohol. The electrode 10 comprises a metal adapted (configured) to react (convert) alcohol and a non-metallic material, wherein the non-metallic material comprises: glass, silicate, polypropylene and/or polyethylene.

FIG. 2 shows that the electrode 10 shown in FIG. 1 can be formed as an integral component of a layered structure (as a portion of one piece) 20, wherein the electrode 10 can be formed as a first layer of the layered structure 20, and wherein an inert porous carrier layer 11 can be formed as a second layer of the layered structure 20.

The electrode 10 in FIG. 1 and the electrode 10 in FIG. 2 can be porous, as indicated schematically.

In the electrode 10 according to FIG. 1 and in the electrode 10 according to FIG. 2, the metal can preferably comprise gold, platinum, silver, iridium, ruthenium and/or rhodium.

It is not shown that a composition for producing an electrode 10 according to FIG. 1 or FIG. 2 is also provided according to the invention. The composition comprises the metal as a particle, the non-metallic material as a particle, and a dispersant.

In the electrode according to FIG. 1 or FIG. 2 and in the composition, the non-metallic material may comprise glass in a fiber structure.

In the composition, the dispersant may be a volatile dispersant, wherein the dispersant preferably comprises alcohol, in particular ethanol, methanol, n-propanol and/or iso-propanol, and/or water.

FIG. 4 shows an embodiment of a process 200 according to the invention for manufacturing an electrode 10 according to FIG. 2.

The process comprises the steps of: S1 providing the composition, S2 applying the composition to the inert porous carrier layer 11, and S3 removing the dispersant.

In one embodiment, the electrode 10 according to FIG. 2 may be obtained by the process 200 described above.

FIG. 3 shows an electrochemical gas sensor 100 for measuring alcohol. In the example shown, the electrochemical gas sensor 100 comprises the electrode 10 according to FIG. 2, wherein the electrode 10 is configured as a measuring electrode, and an electrolyte 30, which is adapted (configured) to wet the electrode 10 and the porous carrier layer 20. The electrochemical gas sensor 100 can comprise further components not shown. Although the electrolyte 30 is arranged in the entire electrochemical gas sensor 100 in the schematic representation, it is known that the electrolyte 30 can occupy only a part of an internal volume of the electrochemical gas sensor 100.

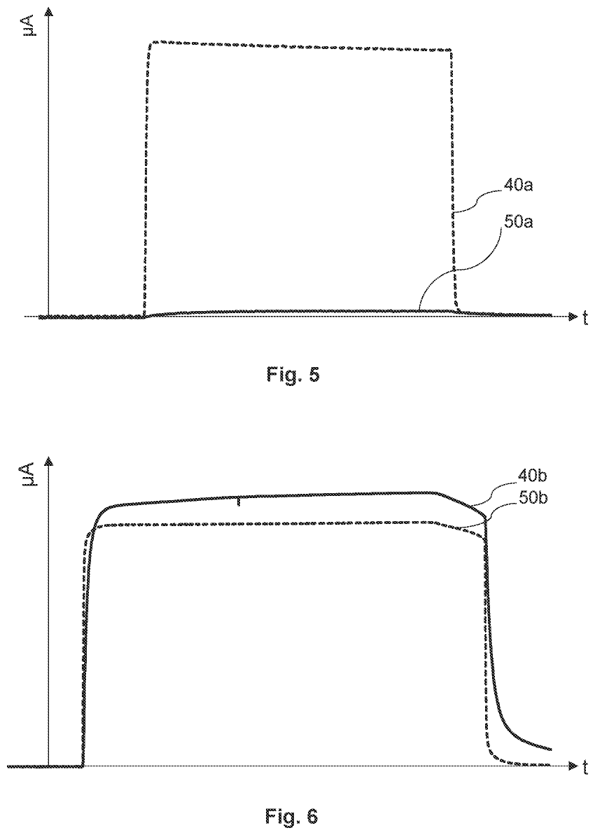

The advantageous effect of the electrochemical gas sensor 100 according to the invention is also illustrated by two diagrams shown in FIGS. 5 and 6.

FIG. 5 shows a first diagram with initial measured values of a test with an electrochemical gas sensor 100 according to the invention, shown as a continuous line 50a, and with a known sensor, shown as a dashed line 40a. In this experiment, an electrochemical gas sensor 100 according to the invention and a known sensor based on platinum were gassed with 100 ppm CO and the measurement signal resulting from the gassing was plotted in μA over the time t. The known sensor is configured to measure organic vapors. It can be clearly seen that the known sensor provides a high measurement signal when gassed with CO, whereas the electrochemical gas sensor 100 according to the invention only provides a low measurement signal. Consequently, the gas sensor 100 according to the invention advantageously offers a significantly lower cross-sensitivity to CO.

FIG. 6 shows a second diagram with second measured values of a test with the same electrochemical gas sensor 100 according to the invention as in FIG. 5, shown as continuous line 40b and with the same known sensor as in FIG. 5, shown as dashed line 50b. In this experiment, the electrochemical gas sensor 100 according to the invention and the known sensor were gassed with 250 ppm ethanol dry gas and the measurement signal resulting from the gassing was plotted in μA over the time t. It is easy to see that the electrochemical gas sensor 100 according to the invention and the known sensor have an approximately comparable sensitivity to ethanol.

From the synopsis of the exemplary tests according to FIGS. 5 and 6, it becomes clear that the electrochemical gas sensor 100 according to the invention has a reduced cross-sensitivity to CO with simultaneously good sensitivity to alcohol compared to a known sensor.

While specific embodiments of the invention have been shown and described in detail to illustrate the application of the principles of the invention, it will be understood that the invention may be embodied otherwise without departing from such principles.

### LIST OF REFERENCE CHARACTERS

10 Electrode
11 Carrier layer
20 Layered structure
30 Electrolyte
50a,40b Measurement time courses (continuous line) of an electrochemical gas sensor according to the invention
40a, 50b Measurement time courses (dashed line) of a known sensor
100 Electrochemical gas sensor
200 Procedure
S . . . Steps of the process

What is claimed is:

1. A composition for making an electrode for use in an electrochemical gas sensor for measuring alcohol, the composition comprising:
particles of a metal configured to convert alcohol;
particles of a non-metallic material; and
a dispersing agent,
wherein the non-metallic material comprises glass.

2. A composition according to claim 1, wherein the dispersing agent is a volatile dispersing agent.

3. A composition according to claim 1, wherein the dispersing agent comprises ethanol, methanol, n-propanol and/or iso-propanol, and/or water.

4. A composition according to claim 1, wherein the metal comprises: gold, platinum, silver, iridium, ruthenium and/or rhodium.

5. A composition according to claim 1, wherein the non-metallic material comprises glass in fiber structure.

6. A composition according to claim 1, wherein the fiber structure has a length of at least 1 μm and another dimension of at least 0.25 μm.

7. A process of manufacturing an electrode, the process comprising the steps of:
providing a composition comprising: particles of a metal configured to convert alcohol; particles of a non-metallic material; and a dispersing agent, wherein the non-metallic material comprises glass;
applying the composition to an inert porous carrier layer; and
at least partially removing the dispersing agent.

8. An electrode formed by a process comprising the steps of:
providing the composition comprising: particles of a metal configured to convert alcohol; particles of a non-metallic material; and a dispersing agent, wherein the non-metallic material comprises glass;
applying the composition to an inert porous carrier layer; and
at least partially removing the dispersing agent,
wherein the electrode is formed as an integral component of a layered structure,
wherein the electrode is formed as a first layer of the layered structure, and
wherein the inert porous carrier layer is formed as a second layer of the layered structure.

9. An electrode according to claim 8, wherein the electrode is porous.

10. An electrode according to claim 8 in combination with an electrolyte configured to wet the electrode and the inert porous carrier layer to form an electrochemical gas sensor for measuring alcohol, wherein the electrode is configured as a measuring electrode.
